(19) United States
(12) Patent Application Publication
(10) Pub. No.: US 2008/0263077 A1
(43) Pub. Date: Oct. 23, 2008

(54) Systems, methods, website and computer products for service ticket consolidation and display

(76) Inventor: Christopher Boston, Acworth, GA (US)

Correspondence Address: CANTOR COLBURN LLP - AT&T, 20 Church Street, 22nd Floor, Hartford, CT, 06103, US

(21) Appl. No.: 11/788,091

(22) Filed: Apr. 19, 2007

(51) Int. Cl. G06F 17/30

(52) U.S. Cl. 707/102

(57) ABSTRACT

Systems, methods, website and computer products for service ticket consolidation and display. Exemplary embodiments include a service ticket display method, including generating a service ticket from a ticket service application, storing the service ticket in a database, accessing the ticket from the database through a ticket display application and displaying service ticket data on an interface coupled to the ticket display application. Additional exemplary embodiments include a service ticket display system, including a central server, a service ticket process residing on the server for generating service tickets, a database coupled to the server, a service ticket display process residing on the server for managing the service tickets and a display coupled to the server and database for accessing and displaying the service tickets on an interface in response to request to display consolidated ticket status.

### BACKGROUND

The present invention relates generally to service ticket systems, and more particularly, to systems, methods, website and computer products for service ticket consolidation and display.

Providers of goods and services often require service calls, which typically begin with a contact for a service request. When a customer contacts the provider, the customer service representative opens a ticket, which can include customer information, the nature of the problem, classification of the problem, ticket date, etc. Tickets are open in trouble ticketing systems such as Remedy®. At any given time, there may be a large number of active tickets that can be accessed by interested users such as customer services representatives (call analysts), technicians assigned to the ticket, managers, etc. Tickets are typically stored in a database that can be accessed by any of the aforementioned interested parties. However, active tickets are typically accessible one ticket at a time and there lacks a system and method for a consolidated view of tickets to provide a quick and accurate summary of all tickets.

### BRIEF SUMMARY

Exemplary embodiments include a service ticket display method, including generating a service ticket from a ticket service application, storing the service ticket in a database, accessing the ticket from the database through a ticket display application and displaying service ticket data on an interface coupled to the ticket display application.

Additional exemplary embodiments include a service ticket display system, including a central server, a service ticket process residing on the server for generating service tickets, a database coupled to the server, a service ticket display process residing on the server for managing the service tickets and a display coupled to the server and database for accessing and displaying the service tickets on an interface in response to a request to display consolidated ticket status.

Further exemplary embodiments include a method of providing and selecting from a menu for consolidated service ticket presentation on the display, the method being in a computer system having a graphical user interface including a display and a selection device, the method including retrieving a set of menu entries for the menu, each of the menu entries representing a filter icon for a consolidated view of service tickets in consolidated service ticket presentation windows, displaying the set of menu entries on the display, receiving a menu entry selection signal indicative of the selection device pointing at a selected menu entry from the set of menu entries and in response to the signal, performing a search of a database for a match to the service ticket presentation filtered by the selected menu entry.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 illustrates an exemplary ticket consolidation and display system;

FIG. 2 illustrates an exemplary service ticket presentation interface;

FIG. 3 illustrates filter/search toolbar in accordance with exemplary embodiments;

FIGS. 4A-4C illustrate active states of an exemplary ticket presentation interface;

FIG. 5 illustrates a ticket presentation interface in accordance with exemplary embodiments;

FIG. 6 illustrates a report generation interface in accordance with exemplary embodiments;

FIG. 7 illustrates an exemplary timer interface;

FIG. 8 illustrates an exemplary delete ticket interface; and

FIG. 9 illustrates a service ticket consolidation method in accordance with exemplary embodiments.

The detailed description explains the exemplary embodiments, together with advantages and features, by way of example with reference to the drawings.

### DETAILED DESCRIPTION OF EXEMPLARY EMBODIMENTS

Exemplary embodiments include systems and methods for providing a call service center (e.g., a network operations center) a consolidated view of active service tickets that are generated by ticketing systems, such as Remedy®. In exemplary implementations, the system provides various ticket timers to update ticket status and presentation to the call center analysts. The ability for the call center analysts to set manual timers other than those imposed by the ticketing system can be set and utilized for various process functions. Features such as portability, scalability, etc. of the systems allows for adaptation to many environments that use ticketing systems such as Remedy®. In other exemplary embodiments, the system can be modified for use by customers as an additional service by the provider. The system can further be modified so that multiple call centers that use trouble ticketing systems can use the system. As such, a call center analyst is presented with a clean view of the current tickets in the system via a graphical user interface (GUI) (e.g., a web browser). According to exemplary embodiments, the analyst can then sort or view only those tickets that they need to work on. Timers can be set on a per ticket basis either implementing timers provided by the underlying ticketing system or through manual timers provided via a GUI. Timers can be set by call analysts in order to monitor particular tickets and be alerted when the timers have expired. Thus, the system provides analysts with the ability to prioritize what tickets need attention first. The systems and methods described herein present a strictly defined set of data points that can contain thousands of data points per ticket. This flexibility allows the end user to see what they need when they need it and be able to act accordingly.

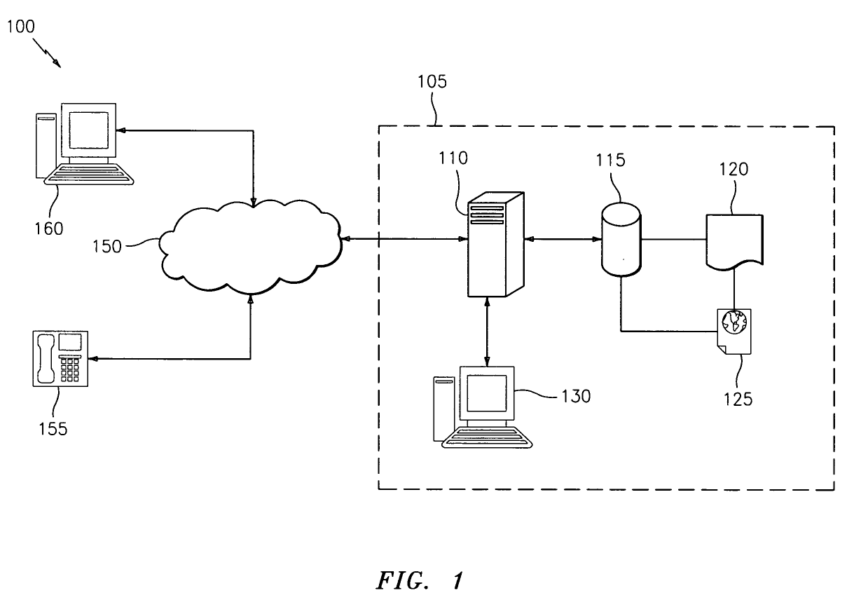

FIG. 1 illustrates an exemplary ticket consolidation and display system 100. In an exemplary embodiment, system 100 includes a service center 105, which can be coupled to and in communication with a network 150. Network 150 can be an IP-based network for communication between customer service center 105 and clients using communication devices such as, but not limited to, a telephone 155, a computer 160, etc., via a broadband connection. In exemplary embodiments, network 150 can be a managed IP network administered by a service provider, which can control bandwidth and quality of service for voice streams. Network 150 can also be a packet-switched network such as a local area network, wide area network, metropolitan area network, Internet network, or other similar type of network environment. Network 150 may be a cellular communications network, a fixed wireless network, a wireless local area network, a personal area network (PAN) or other suitable network system and includes equipment for receiving and transmitting signals such as a cell tower and mobile switching center. Therefore, network 150 may be implemented using wireless protocols and technologies, such as WiFi, WiMax, etc. In another exemplary embodiment, network 150 can be a circuit-switched network such as a standard public switched telephone network (PSTN).

Service center 105 can include a central server 110 for processing, storing and otherwise managing data related to service requests and corresponding tickets. The aforementioned data can be subsequently stored in a storage medium 115 coupled to server 110. A ticket system application 120 can reside on storage medium 115. A service ticket presentation application 125 can also reside on storage medium 115 and be coupled to ticket system application 120. A call analysis device 130, such as a computer work station, can be coupled to and in communication with server 110. Therefore, a call analyst can access ticket system application 120 and service ticket presentation application 125 as needed to enter, process, update, or otherwise manage service tickets in storage medium 115 as customers contact service center 105. It is understood that technicians, managers and other interested parties can also access server 110 and storage medium 115 as needed, and accordingly interact with the GUI on call analysis device 130.

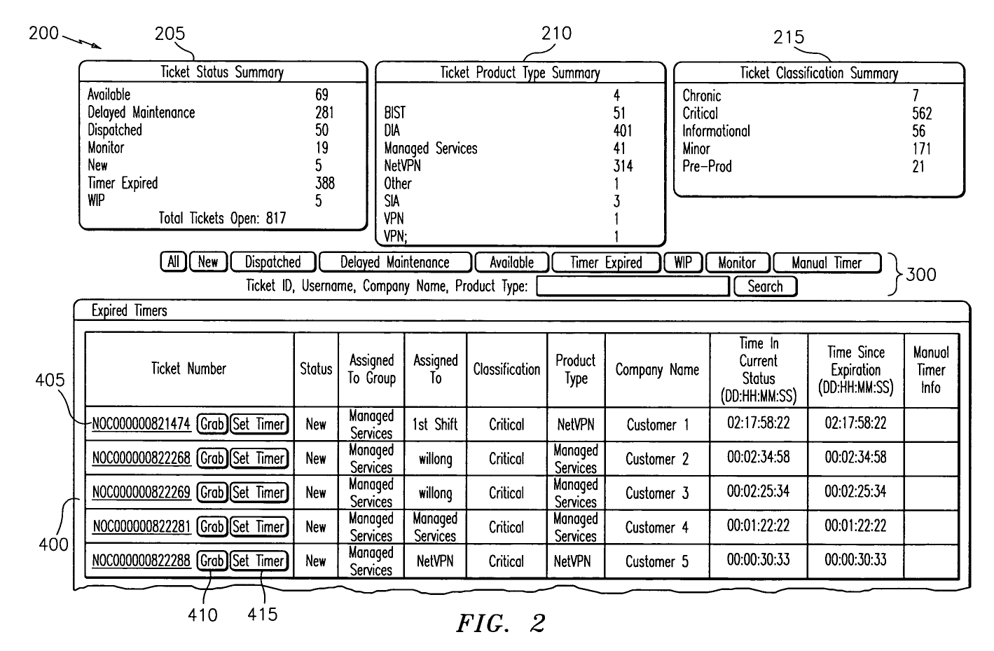

As discussed above, service ticket presentation application 125 is coupled to ticket system application 120 to provide a consolidated service ticket interface. FIG. 2 illustrates an exemplary service ticket presentation interface 200. In an exemplary implementation, the service ticket presentation interface is provided when the service ticket presentation application 125 is accessed. Ticket presentation interface 200 can include a ticket status summary window 205, a ticket product type summary window 210, a ticket classification summary window 215, a filter/search toolbar 300 and a ticket detail window 400.

Ticket status summary window 205 may include a summary of ticket counts by their status. Ticket status summary window 205 can aid a call analyst in obtaining a quick count of the total number of tickets as well as the current number of tickets having a particular status. Status of tickets can include available, delayed maintenance, dispatched, monitor, new, timer expired, WIP (work in progress), etc. In general, an available ticket means that a ticket is available to be worked by any of the call analysts. A delayed maintenance ticket means that an action has been taken and the analyst has to wait until completion of the action. A ticket is in the monitor state when a problem has possibly been corrected and an analyst is watching the ticket to see the resolution. A new ticket is new in the ticket queue and no analyst has taken any action with it yet. A timer expired ticket means that either an automated ticket service application timer or a manual timer has expired. A WIP ticket means that work is actively being performed on the ticket.

According to exemplary embodiments, ticket product type summary window 210 includes a summary of ticket counts by the product type, the total number corresponding to the total number shown in ticket status summary window 205. Ticket product type summary window 210 can aid a call analyst in obtaining a quick count of the total number of tickets as well as the current number of tickets having a particular product type. Product types can include any number of products. For example, for a phone and Internet provider, the products can include a integrated service transport (IST), dedicated internet access (DIA), managed service, such as a customer owned network in which the provider is monitoring and managing, a VPN network having multiple sites linked via VPN, other (a catch all for all other product types, state Internet access (SIA), and VPN for non-standard VPN users. It is understood that the aforementioned product types are discussed for illustrative purposes. In other exemplary embodiments and implementations, the product types can vary.

Ticket classification summary window 215 includes a summary of ticket counts by their classification, the total number corresponding to the total number shown in ticket status summary window 205 and in ticket product type summary window 210. Ticket classification summary window 215 can aid a call analyst in obtaining a quick count of the total number of tickets as well as the current number of tickets having a particular classification. Classification types can include but is not limited to: chronic; critical; informational; minor; pre-prod, etc. In general, “chronic” means that the problem is re-occurring. “Major” means that multiple customer or service is affected by an outage. A “critical” problem is a problem needing immediate attention. “Informational” means that the service request is for information regarding a product/service. “Minor” refers to a problem that does not require immediate attention. “Pre-prod” refers to pre-production or a request on a service or product that is not yet in production, such as a beta-test.

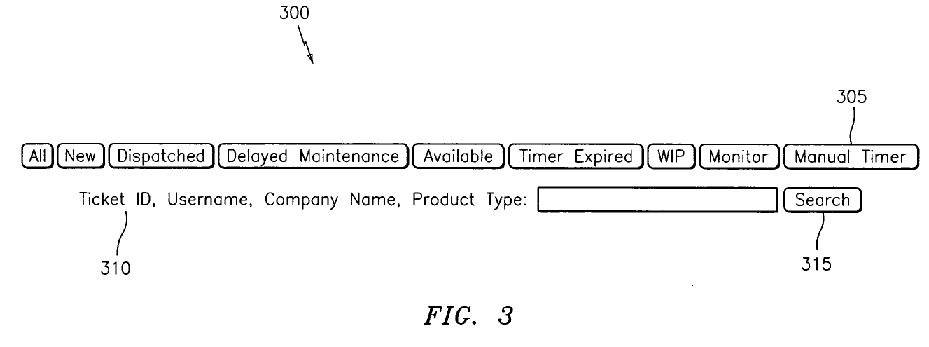

As discussed above, interface 200 may further include filter/search toolbar 300. FIG. 3 illustrates filter/search toolbar 300 in accordance with exemplary embodiments. Filter/search toolbar 300 can allow a user to filter and/or search the current ticket base for specific ticket information. Pre-defined buttons 305 can, for example, allow a user to see all tickets for a particular status type by clicking one of the buttons 305. An “all” button allows all tickets to be displayed in ticket detail window 400. As discussed above, other statuses of tickets can include but is not limited to: new; dispatched; delayed maintenance; available, timer expired. WIP; monitor; manual timer, etc. By clicking on the status buttons 305, a user can quickly view the ticket status type in the ticket detail window 400.

Filter/search toolbar 300 can further include a data field 310 for searching for particular ticket criteria. For example, tickets can be searched by ticket ID, username, company name, product type, etc. By entering the search data in the data field 310 and clicking search button 315, a user can obtain the desired ticket information in ticket detail window 400.

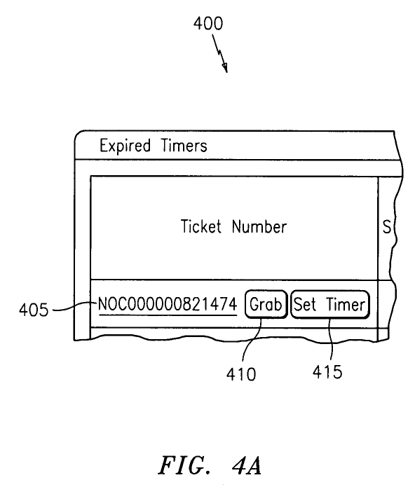

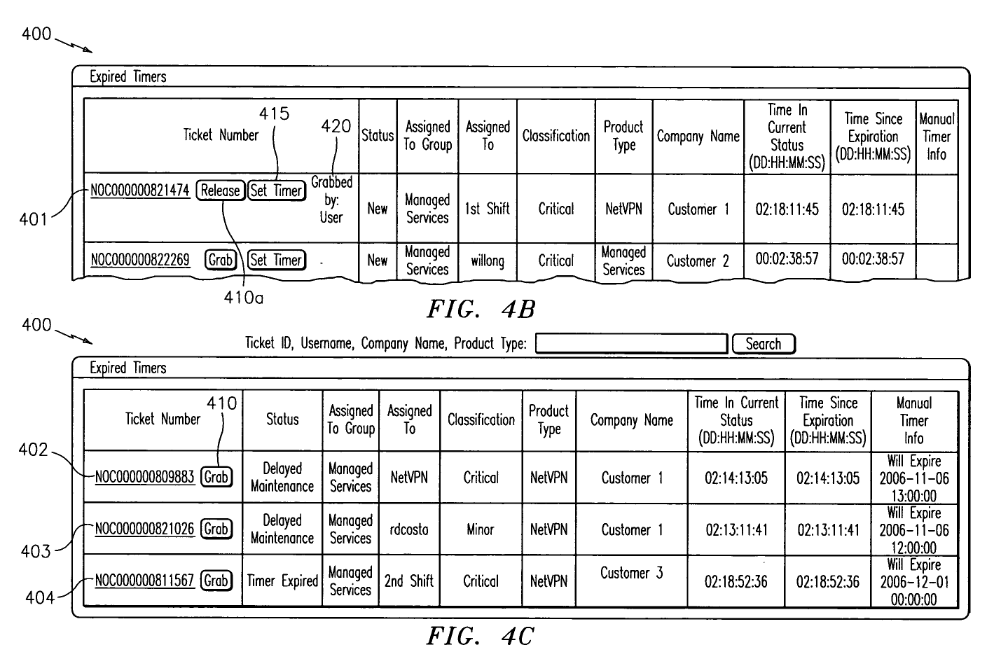

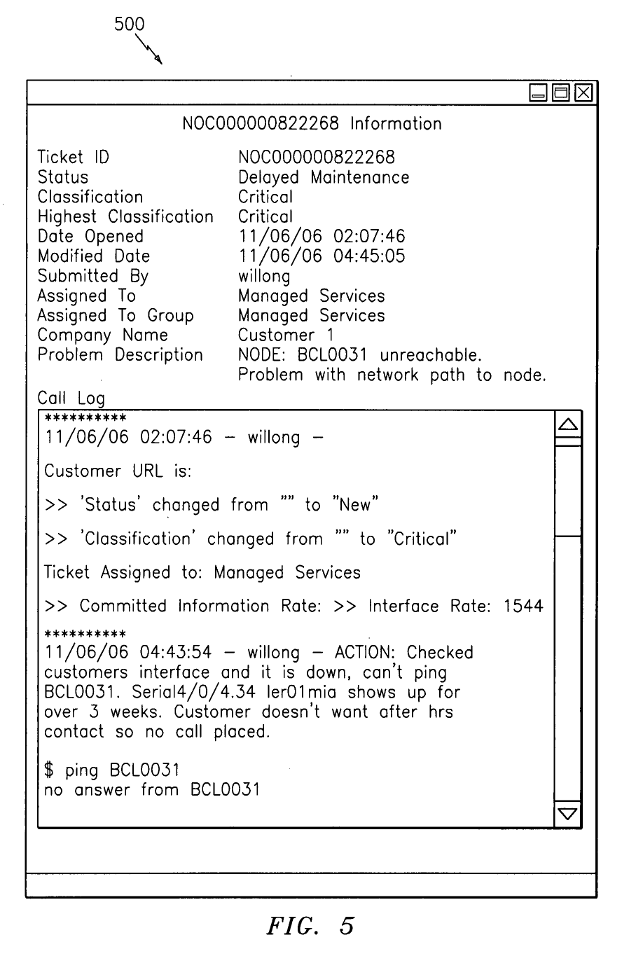

Referring again to FIG. 2, interface 200 further includes ticket detail window 400. Ticket detail window 400 can be presented in row and column format, each row generally representing a ticket. Columns may represent different aspects of the ticket, including, but not limited to: ticket number; status (as discussed above, which can be filtered as further discussed above); the group to which the ticket is assigned; the specific person or group to which the ticket is assigned; classification of the ticket (as discussed above); product type (as discussed above); company/customer name; time in current status; time since expiration; manual timer information, etc. The ticket number column can include links 405 to another window having detailed information about the individual ticket, which is discussed further in the description below with respect to FIG. 5. Ticket detail window 400 further includes a grab button 410 and a set timer button 415, which are now described in further detail. Reference is made to FIGS. 4A-4C.

FIG. 4A illustrates a close up view of a portion of ticket detail window 400, showing link 405, “grab” button 410 and set timer button 415. According to exemplary embodiments, “grab” button 410, allows a user to mark the ticket in this application as “grabbed” by the particular user. This ability allows other users to know when a ticket is being actively worked by another user, which reduces or eliminates duplication of effort and allows other users to know who to go to if they have questions about a particular ticket. FIG. 4B illustrates ticket detail window 400 with a ticket row 401 having had grab button 410 clicked, which changes grab button 410 to release button 410a. Furthermore, a message field 420 may be displayed indicating that a particular user has “grabbed” the ticket. Furthermore, ticket rows of the ticket detail window 400, such as the ticket row 401, can change appearance, which can be in the form of a color change, thereby providing a further visual indication that the ticket associated with the ticket row is “grabbed”.

FIG. 4C illustrates ticket detail window 400 with ticket rows 402, 403, 404 having respective grab buttons 410 clicked. In an exemplary implementation, the set timer buttons 415 associated with the ticket rows 402-404 are removed from the display and an expiration time is placed in a manual timer info column associated with the ticket rows 402, 403, and 404. Rows 402, 403, and 404 can also change their appearance, which can be in the form of a color change, thereby providing a further visual indication that the user has set a manual timer that is due to expire. In general, the appearance change occurs when the set timer button is used In general, one manual timer for a given ticket is set at one time. Once a previous timer that has been set has expired, another analyst can set a new timer if needed. These timers are set as a reminder that a particular action should occur at a given time. In general, the details of a given action are stored in another data location of a given ticket. In other exemplary implementations, other alerts can be provided to a call analysis such as an email notification. In still other implementations, a pop-up notification can be generated for a call analyst. The users can therefore have visual indication that the tickets require attention during the time that they are under a color change. When the manual timers are set and subsequently expire, the set timer buttons 415 may reappear, and the rows 402, 403, and 404 may return to an original color associated with the rows prior to the set timer buttons 415 being selected.

Referring again to FIG. 2 and FIGS. 4A-4C, ticket detail window 400 further includes links 405 to additional windows that provide further ticket information. FIG. 5 illustrates a ticket presentation interface 500 in accordance with exemplary embodiments. In an exemplary implementation, the ticket presentation interface 500 is provided when a link associated with a ticket is selected. Link 405 (FIG. 2) may provide the user the ability to query the actual ticket application 120 (e.g., through Remedy®) and pull a real time status of the information in the ticket. Although a ticket can include more data than presented on interface 500, fields provide data that an analyst needs to make a determination on the ticket. Therefore, interface can include fields for data, such as, but not limited to: ticket ID; status; classification; highest classification; date opened; modified date; submitted by (user); assigned to; assigned to group; company/customer name; problem description, etc. Interface 500 can further include a call log to track all data and calls related to the problem.

It is appreciated that interface 200 can include a number of other interface windows that aid in ticket management. For example, FIG. 6 illustrates a report generation interface 600 in accordance with exemplary embodiments. Interface 600 provides a front end to a log search. Interface 600 allows a user to search for any activity that has been performed by a user or on a ticket. Interface 600 can include search field 605, having menu 610 for choosing search criteria which, by way of example, can be by user name, ticket ID etc. When the user has chosen and entered the desired search criteria via field 605 and menu 610, the user can click generate report button 615 to obtain the aforementioned activity.

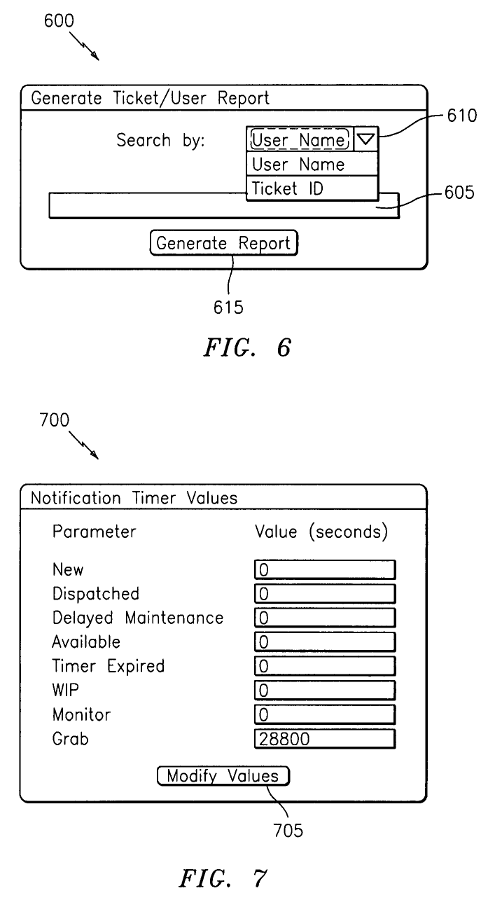

FIG. 7 illustrates an exemplary timer interface 700. Interface 700 is the management interface to set up timeout values for timers that are native to the underlying ticket system application 120 (e.g., Remedy®). As discussed above, a user can set manual timers via interface 200. However, in other exemplary implementations, a user may want to access the native timers. Interface 700 can be utilized to “hide” tickets until their time has been expired for a given amount of time. As discussed above, tickets are assigned a status. Each status can include an associated default timer setting representing the time allotted to the status. The statuses include but are not limited to: new; dispatched; delayed maintenance; available; timer expired; WIP; monitor; grab, etc. In a default setting, all of the timers are set to 0 by management so that all tickets show up immediately. In an exemplary implementation, the grab timer default can be set to some non-zero value. Therefore, by assigning a non-zero time to the grab timer, a “grabbed” ticket is released after the preset non-zero time. If desired, a user can enter other times into the appropriate data fields and click a modify values button 705 to update the timers.

FIG. 8 illustrates an exemplary delete ticket interface 800. In general, if a ticket is complete or has otherwise expired and become stale, a user can delete the ticket from system 100 via interface 800. Interface 800 includes a field 805 for entry of the ticket number to delete. When the ticket number is entered, the user can click a delete ticket button 810 to remove the ticket from storage medium 115, and therefore system 100.

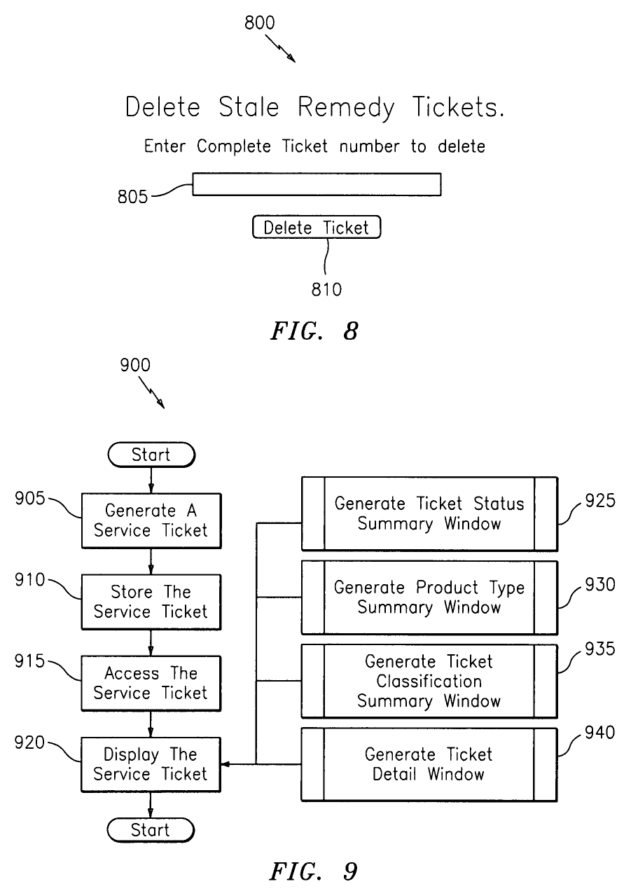

FIG. 9 illustrates a service ticket consolidation method 900 in accordance with exemplary embodiments. In general, at step 905, a service ticket can be generated from the ticket service application 120. At step 910, the service ticket can be stored in a database such as on storage medium 115. Subsequently, at step 915, the service ticket can be accessed from the database. In general, the ticket is accessed through the ticket display application 125. At step 920, the service ticket can be displayed. As discussed above, several windows and associated toolbars can be generated. At step 925, the ticket status summary window 205 can be generated. At step 930, the ticket product type summary window 210 can be generated. At step 935, the ticket classification summary window 215 can be generated. At step 940, the ticket detail window 400 can be generated.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A service ticket display method, comprising:
generating a service ticket from a ticket service application, the service ticket having a first status;
storing the service ticket in a database;
accessing the ticket from the database through a ticket display application;
displaying service ticket data on an interface coupled to the ticket display applications;
associating a timer with the service ticket, the timer configured to set an expiration time period during which a set of actions associated with the service ticket are identified for completion; and
in response to a passage of the expiration time period and a failure to complete the set of actions prior to the expiration of the expiration time period, generating an alert indicating that the service ticket has attained a second status.

2. The method as claimed in claim in 1 further comprising generating a ticket status summary window on the interface.

3. The method as claimed in claim 2 further comprising generating a ticket product type summary window on the interface.

4. The method as claimed in claim 3 further comprising generating a ticket classification summary on the interface.

5. The method as claimed in claim 1 further comprising generating a ticket detail window on the interface.

6. The method as claimed in claim 5 further comprising generating a toolbar on the interface.

7. The method as claimed in claim 6 wherein the toolbar includes graphical icons for filtering the service ticket data for display in the ticket detail window.

8. The method as claimed in claim 7 wherein the service ticket data is organized based on a ticket status summary, the ticket status summary including the first and second status.

9. The method as claimed in claim 8 wherein the ticket status summary includes at least one of available, delayed maintenance, dispatched, monitor, new, timer expired, and work in progress.

10. A service ticket display system, comprising:
a central server;
a service ticket process residing on the server for generating service tickets;
a database coupled to the server;
a service ticket display process residing on the server for managing the service tickets; and
a display coupled to the server and database for accessing and presenting the service tickets on an interface in response to a request to display consolidated ticket status.
wherein the interface includes a set timer button configured to activate a timer configured to set an expiration time period during which a set of actions associated with the service ticket are identified for completion, and
wherein the interface further includes a grab button configured to change a status associated with the service ticket, the status indicating that service ticket has been addressed, wherein the grab button is configured to change appearance to a release button in response to the grab button being activated.

11. The system as claimed in claim in 10 further comprising service ticket data stored in the database.

12. The system as claimed in claim 11 further comprising a ticket status summary window residing on the interface for displaying the service ticket data.

13. The system as claimed in claim 12 further comprising a product type summary window residing on the interface for displaying the service ticket data.

14. The system as claimed in claim 13 further comprising a ticket classification summary window residing on the interface for displaying the service ticket data.

15. The system as claimed in claim 14 further comprising a ticket detail window residing on the interface for displaying the service ticket data.

16. In a computer system having a graphical user interface including a display and a selection device, a method of providing and selecting from a menu for consolidated service ticket presentation on the display, the method comprising:
retrieving a set of menu entries for the menu, each of the menu entries representing a filter icon for a consolidated view of service tickets in consolidated service ticket presentation windows;
displaying the set of menu entries on the display;
receiving a menu entry selection signal indicative of these selection device pointing at a selected menu entry from the set of menu entries;
in response to the signal, performing a search of a database for a match to the service ticket presentation filtered by the selected menu entry;
receiving a grab button selection signal indicative of the selection device pointing at a grab button associated with a service ticket;
in response to the signal, placing an indication on the display that the service ticket has been addressed;
receiving a timer selection signal indicative of the selection device pointing at a timer associated with a service ticket; and
in response to the signal, starting the timer during which a set of actions are to be completed.

17. The method as claimed in claim 16, wherein the filter icons are selected to display the consolidated ticket presentation based on at least one of: all tickets, delayed maintenance tickets, dispatched tickets, monitored tickets, new tickets, tickets with expired timers, and work in progress tickets.

18. The method as claimed in claim 17 wherein the ticket presentation windows include at least one of a ticket status summary window, a ticket product type summary window, and a ticket classification summary window.

19. The method as claimed in claim 16 wherein the ticket presentation windows comprise a ticket detail window for displaying the consolidated view of service tickets in response to the selection device signal indicative of a filter icon selection.

20. The method as claimed in claim 19 further comprising displaying links in the ticket detail window for linking to a ticket presentation interlace in response to a signal indicative of the selection device pointing at the link, the ticket presentation interface providing details specific to a service ticket.
